(19) United States
(12) Patent Application Publication
(10) Pub. No.: US 2026/0092665 A1
(43) Pub. Date: Apr. 2, 2026

(54) VACUUM PUMP WITH INTAKE FITTING

(71) Applicant: Uniweld Products, Inc., Fort Lauderdale, FL (US)

(72) Inventors: Douglas B. Pearl, Fort Lauderdale, FL (US); David Foster, Tamarac, FL (US)

(21) Appl. No.: 18/903,444

(22) Filed: Oct. 1, 2024

(51) Int. Cl. F16L 41/02; F16L 15/00

(52) U.S. Cl. CPC F16L 41/023; F16L 15/006

(57) ABSTRACT

Vacuum pump assembly including an intake port and an intake fitting directly coupled to the intake port; the intake fitting having a base and a Y-shaped region extending from the base. The Y-shaped region includes first and second angled members, the base having a first bore in fluid communication with second and third bores respectively in each of the first and second angled members. The base has external threads configured to mate directly with internal threads in the intake port, eliminating a fitting between the pump intake port and the intake fitting. The intake fitting may include a leg positioned between the first and second angled members and in a common plane therewith. The vacuum pump may have a compressor and a drive for the compressor.

### BACKGROUND

Vacuum pumps are pervasively used by HVAC and refrigeration technicians to, for example, create negative pressure in order to remove contaminants (e.g., air and non-condensables (e.g., water, water vapor) from HVAC and refrigeration systems. The presence of such contaminants in these systems is usually deleterious to the efficient operation of the apparatus, and can eventually result in corrosion of components and other poor outcomes. Evacuating such systems with vacuum pumps is usually carried out when a system must undergo repair (after the refrigerant has been recovered), when recharging a system with refrigerant, or to charge a new system with refrigerant.

Typical conventional vacuum pumps include a compressor and a motor to drive it the compressor. The pump also includes an inlet for fluid connection to a hose or the like to provide fluid communication between the vacuum pump and the HVAC or refrigeration system to be evacuated, and an outlet that typically exhausts to atmosphere. Two-stage vacuum pumps displace the air which is pulled through the intake fitting and is compressed in the a first and second stage before it is exhausted to achieve a negative pressure down to about 500 microns or less, preferably as low as 50 microns.

Conventional vacuum pumps for HVAC and refrigeration system evacuation have an intake port configured to receive a T-shaped adapter so that two hoses of the same diameter (e.g., ⅜″) may be connected to and be in fluid communication with the pump simultaneously. Thus the conventional T-adapter is connected to an intake port on the pump and has two opposite spaced connections for hoses in order to provide a dual hose connection to the pump. However, the shape of the T-adapter causes the molecules entering the T-adapter to collide, resulting in turbulent flow. The use of a Y-shaped adapter connected to the T-adapter can improve the flow, but conventional Y-adapters can be cumbersome to use.

When evacuating HVAC and refrigeration systems with a vacuum pump, it is generally desirable to achieve as low a negative pressure as possible in as short a time as possible. It is therefore an object of the embodiments disclosed herein to provide an intake fitting and a vacuum pump with an intake fitting that simplifies the equipment and reduces the amount of time needed to evacuate an HVAC or refrigeration system to a desired level compared to conventional vacuum pump assemblies.

### SUMMARY

Problems of the prior art have been addressed by embodiments disclosed herein, which relate to intake fittings and vacuum pumps with intake fittings. In certain embodiments, the vacuum pump has an intake fitting coupled directly to a port formed in the pump body. The intake fitting may be integral to the pump or threadingly attached directly to the pump. In certain embodiments the intake fitting has first and second spaced members terminating in respective free ends preferably of the same outside diameter for receiving respective hoses. The intake fitting optionally may have a third member with a free end diameter different from the free end diameters of the first and second spaced members for connection to a different diameter hose. The intake fitting optionally may have a fourth member or leg with a free end diameter different from the free end diameters of the first and second spaced members, the optional fourth member being positioned in a common plane with the first and second spaced members and between the first and second spaced members. For example, the respective longitudinal centerlines 215a, 215b extending through the respective bores 115a, 115b of the first and second members 15a, 15b and the longitudinal centerline 215c extending through the bore 115c of the fourth member 15c define a common plane. In certain embodiments, the fourth member positioned in a common plane with the first and second members may be used in an intake fitting devoid of the third member. In certain embodiments, the outside diameters of the respective free ends of the first and second spaced members are each of a size effective for receiving a ⅜ inch fitting on a refrigeration hose, such as a ½ inch diameter refrigeration hose. In certain embodiments, the optional third member has a free end with an outside diameter effective for receiving a ¼ inch fitting on a hose. In certain embodiments, the intake fitting has a Y-shaped cross-section. The intake fitting is coupled or is configured to be coupled directly to the port on the pump with no additional fitting or component between the pump port and the intake fitting. Thus, in certain embodiments external threads on the base of the intake fitting mate with internal threads on the pump port to couple the fitting to the port in sealing relation.

Accordingly, in certain embodiments, disclosed is a vacuum pump assembly comprising an intake port and an intake fitting directly coupled to the intake port; the intake fitting being a unitary body having a base and a Y-shaped region extending from the base, the Y-shaped region comprising first and second angled members terminating in respective free ends, the intake fitting having an internal bore extending through the base and each first and second angled members. In embodiments the vacuum pump may include a compressor and a drive for the compressor.

In certain embodiments, the base has external threads configured to mate in sealing relation with internal threads in the intake port. In certain embodiments, the first and second angled members each have respective free ends with external threads configured to mate with internal threads on a fitting of a respective hose. In certain embodiments, the external threads on each of the free ends of the first and second angled members are sized to receive respective ⅜ inch fittings of a ½ inch diameter refrigeration hose. In certain embodiments, the intake fitting further comprises a ¼ inch member in fluid communication with the internal bore. In certain embodiments, the intake fitting further comprises a fitting positioned between the first and second fittings and in a common plane therewith. In certain embodiments the center fitting is ½″ flare fitting.

In certain embodiments, also disclosed is a connection point between an intake fitting and an intake port on a vacuum pump, the intake fitting being a unitary body having a base and a Y-shaped region extending from the base, the Y-shaped region comprising first and second angled members terminating in respective free ends, the intake fitting having an internal bore extending through the base and each first and second angled members; the connection point consisting essentially of a sealed connection between the intake port and the base of the intake fitting. In embodiments the vacuum pump may a compressor and a drive for the compressor.

The resulting vacuum pump assembly achieves less turbulent flow and surprisingly improved evacuation times of refrigeration systems.

### BRIEF DESCRIPTION OF THE DRAWINGS

FIG. 1 is a top view of an intake fitting in accordance with certain embodiments;

FIG. 2 is a cross-sectional view of the intake fitting of FIG. 1 in accordance with certain embodiments;

FIG. 3 is an exploded front view of the intake fitting of FIG. 1 in accordance with certain embodiments;

FIG. 4 is a side view of the intake fitting of FIG. 1;

FIG. 5 is a perspective view of a vacuum pump having an integral intake fitting in accordance with certain embodiments;

FIGS. 6A, 6B and 6C are diagrams showing the set-up for comparison testing;

FIGS. 7A and 7B are diagrams showing the set-up for comparison testing in accordance with certain embodiments;

FIG. 8 is a top view of an intake fitting in accordance with an alternative embodiment;

FIG. 9 is a cross-sectional view of the intake fitting of FIG. 8 in accordance with certain embodiments; and

FIG. 10 is an exploded front view of the intake fitting of FIG. 8 in accordance with certain embodiments.

### DETAILED DESCRIPTION

A more complete understanding of the components, processes and apparatuses disclosed herein can be obtained by reference to the accompanying drawings. The figures are merely schematic representations based on convenience and the ease of demonstrating the present disclosure, and is, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawing, and are not intended to define or limit the scope of the disclosure. In the drawing and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that do not preclude the possibility of additional components.

All ranges disclosed herein are inclusive of the recited endpoint and independently combinable (for example, the range of “from 2 inches to 10 inches” is inclusive of the endpoints, 2 inches and 10 inches, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.”

It should be noted that many of the terms that may be used herein are relative terms. For example, the terms “upper” and “lower” are relative to each other in location, i.e. an upper component is located at a higher elevation than a lower component, and should not be construed as requiring a particular orientation or location of the structure. As a further example, the terms “interior”, “exterior”, “inward”, and “outward” are relative to a center, and should not be construed as requiring a particular orientation or location of the structure.

The terms “top” and “bottom” are relative to an absolute reference, i.e. the surface of the earth. Put another way, a top location is always located at a higher elevation than a bottom location, toward the surface of the earth.

The terms “horizontal” and “vertical” if used are used to indicate direction relative to an absolute reference, i.e. ground level. However, these terms should not be construed to require structures to be absolutely parallel or absolutely perpendicular to each other.

With respect to the various fittings discussed herein (e.g., ¼″, ⅜″ and ½″ fittings), preferably they are SAE Flare fittings (45° flare).

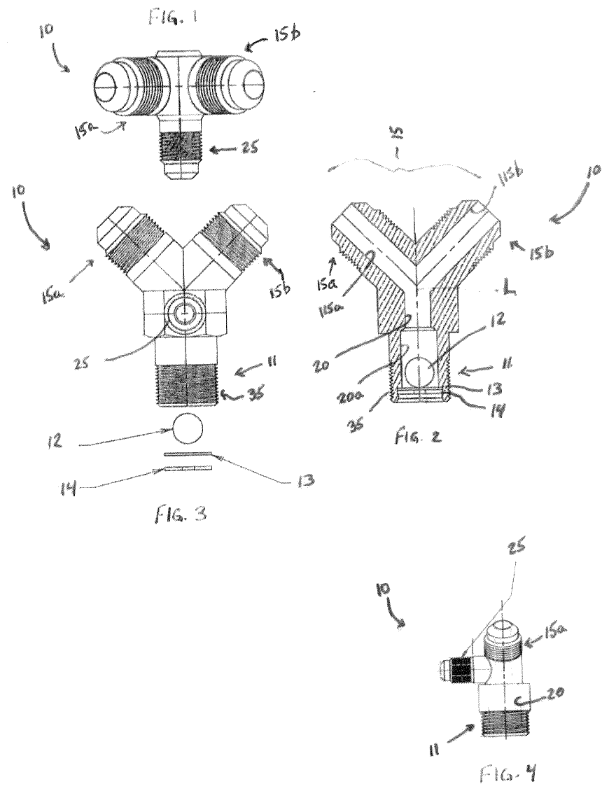

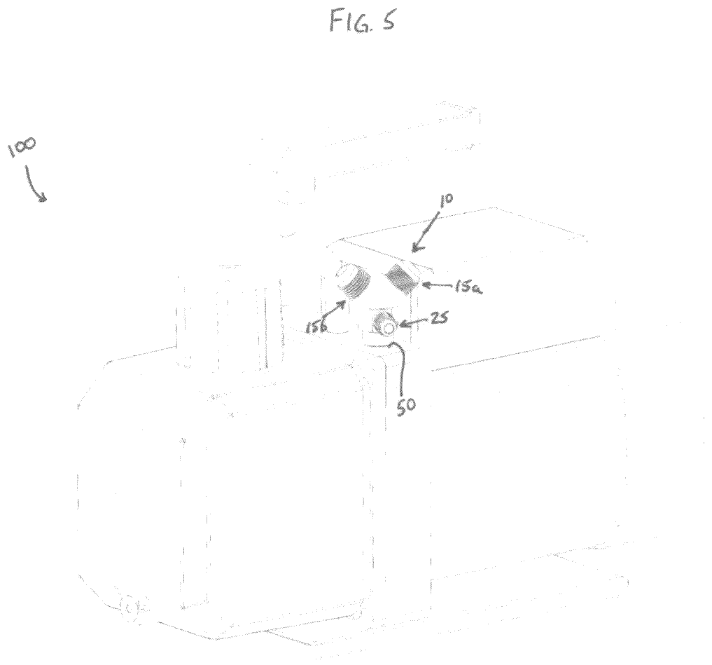

Turning now to FIGS. 1, 2 and 3, there is shown an intake fitting 10 in accordance with certain embodiments. The intake fitting 10 shown has a unitary body and includes an externally threaded base 11 (FIGS. 2 and 3) for direct connection to a port on a vacuum pump. A rubber ball 12, screen 13 and retaining ring 14 to retain the rubber ball in the base 11 (FIGS. 2, 3) may be positioned in the base 11. In certain embodiments, the externally threaded base 11 is configured to be threadingly mated with an intake port 50 on a vacuum pump 100 (FIG. 5), in sealing relation.

The intake fitting 10 of FIG. 2 includes an internal bore 20 that has a generally linear region 20a in base 11 which branches to regions 115a, 115b of first and second angled members or legs 15a, 15b of a Y-shaped region 15. In certain embodiments the first and second angled members or legs 15a and 15b are identically shaped and sized, and each is angled at 45° relative to the longitudinal center line L (FIG. 2) through the base 11, and each terminates in a respective free end as shown. In certain embodiments, each angled member 15a, 15b is externally threaded at or near its respective free end and is configured to receive the internal threads of a respective connection fitting of a refrigeration hose (not shown), such as respective ⅜″ diameter fittings of a ½″ diameter hose.

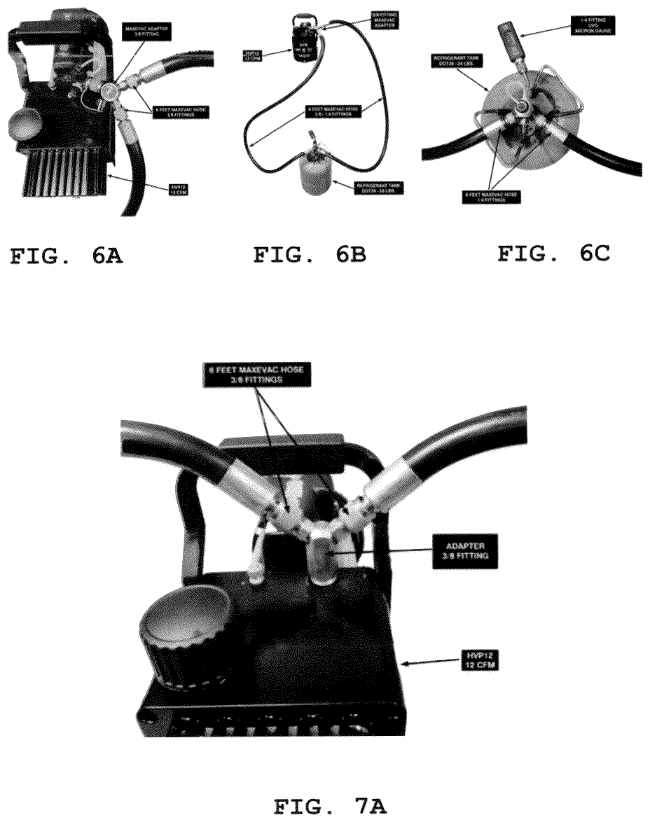

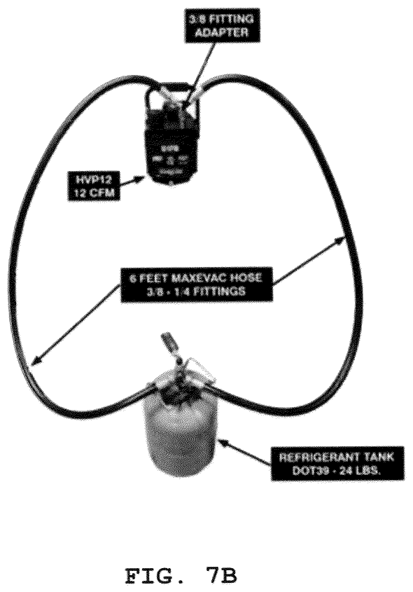

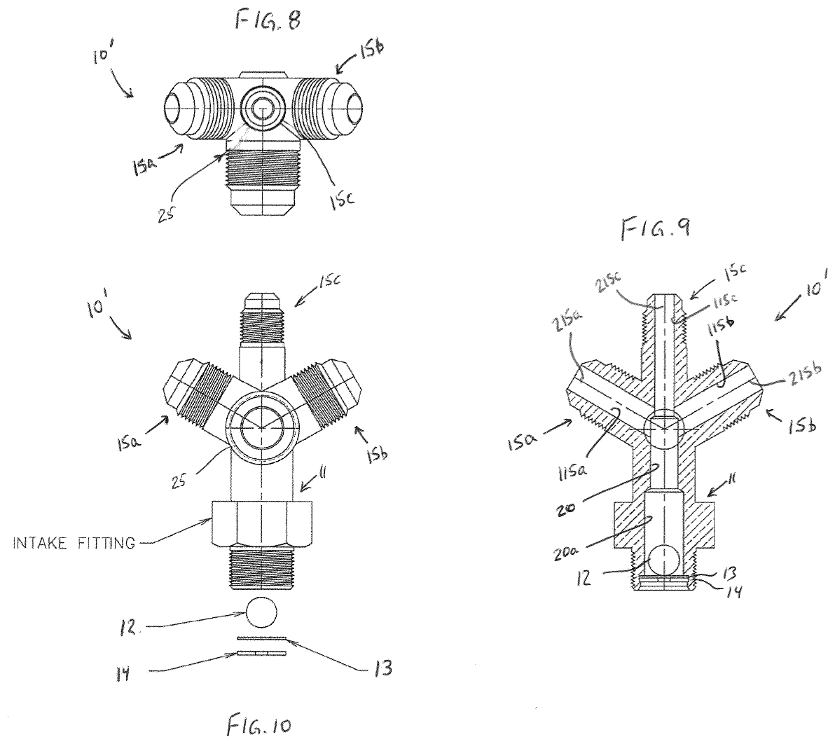

In certain embodiments, the intake fitting 10 may include an additional externally threaded third member 25 (FIG. 4) shaped and configured to receive a ¼″ diameter connection fitting on a refrigeration hose. The member 25 is in fluid communication with the bore 20 (and bores 115a, 115b) and may be capped off or otherwise sealed if not used.

The Y-shape of the intake fitting has a flow path that allows molecules to merge smoothly and provide faster flow than a conventional T-adapter.

In accordance with certain embodiments, the base 11 of the intake fitting 10 is coupled directly to the vacuum pump port 50; there is no additional fitting or component in between the vacuum pump port 50 and the base 11 of the intake fitting 10. In certain embodiments, the external threads 35 on the base 11 extend to the bottom of the base 11 and engage and interlock with internal threads on the port of the pump so that the intake fitting 10 is coupled directly to the pump port 50 in sealing relation. Thus, the intake fitting 10 is a unitary body coupled to the pump port with no other component between the pump port and the intake fitting 10. This is in contrast with conventional Y-adapters, which are coupled to a fitting which in turn is coupled to the pump port.

As used herein, the phrase “consisting essentially of” limits the scope of a claim to the specified components or steps and those that do not materially affect the basic and novel characteristics of the claimed subject matter. The term permits the inclusion of components which do not materially affect the basic and novel characteristics of the apparatus or method under consideration. Accordingly, the expressions “consists essentially of” or “consisting essentially of” mean that the recited embodiment, feature, component, etc. must be present and that other embodiments, features, components, etc., may be present provided the presence thereof does not materially affect the performance, character or effect of the recited embodiment, feature, component, etc. The presence of a fitting or other component between the port 50 on the vacuum pump 100 and the intake fitting 10 of the embodiments disclosed herein is considered to materially affect the performance of the device and is not encompassed within the meaning of “consisting essential of” or “consists essentially of”.

In certain embodiments, evacuation lines (e.g., hoses) may be connected to the various fittings on the intake fitting 10 (or 10′). Typically one evacuation line is used for the high pressure side of an HVAC system and one evacuation line is used for the low pressure side of an HVAC system. For typical large commercial systems, one ½″ fitting and one ⅜″ fitting could be used. In some embodiments, two separate pumps could be used so that there are two available ½ inch fittings, one for the high side and one for the low side, to further increase evacuation speed. For typical smaller systems, e.g., residential systems, one ⅜″ fitting and one ¼″ fitting on the intake fitting 10 may be used.

Turning now to FIGS. 8-10, where like numerals refer to like features of other figures, another embodiment of an intake fitting 10′ is shown. In the embodiment of FIGS. 8-10 first and second angled members or legs 15a, 15b of the Y-shaped region are the same as in the embodiment of FIG. 1. The intake fitting 10′ similarly includes an internal bore 20 that has a generally linear region 20a in base 11 which branches to regions 115a, 115b of first and second angled members or legs 15a, 15b of the Y-shaped region. However, in this embodiment, an additional member, leg or flare 15c is included, positioned between the first and second legs 15a, 15b and in fluid communication with internal bore 20. In certain embodiments the additional leg or flare 15c is positioned in a common plane with the first and second legs 15a, 15b. In certain embodiments it may be configured to receive a ¼ inch, ⅜ inch or ½ inch fitting, such as by external threads positioned thereon as shown. The additional leg 15c allows for the attachment of a different size hose (relative to the first and/or second leg 15a, 15b). In certain embodiments, the additional leg 15c may be provided in an intake fitting devoid of the member 25.

The fitting 10, 10′ thus provides various options for hose size connections. Typically only two will be used at once, and any not in use during a particular evacuation procedure may be capped off such as with a tethered snap on or screw on cap or the like.

While embodiments described herein include a limited number of embodiments, these specific embodiments are not intended to limit the scope as otherwise described and claimed herein. Modification and variations from the described embodiments exist. More specifically, the following example is given as a specific illustration of embodiments disclosed, and it should be understood that the embodiments disclosed are not limited to the specific details set forth in the example.

### Example 1

An evacuation speed comparison was made between a vacuum pump having a Y-adapter connected to an intake fitting connected to a port on a vacuum pump, and a vacuum pump having the intake fitting of the present embodiments, i.e., directly connected to a port on the vacuum pump.

References is made to FIGS. 6A, 6B 6C, 7A and 7B for experimental set-up. The comparative set-up used a conventional Y-adapter with two ⅜″ fittings connected to the single ⅜″ intake fitting of the vacuum pump in accordance with a typical set-up using a MaxEvac™ kit commercially available from Uniweld Products, Inc. This was compared to a vacuum pump having an intake fitting in accordance with embodiments disclosed herein, the intake fitting having two ⅜″ ports for hose connections. The test aimed to determine the time it takes to achieve a pressure of 500 microns in a 24 lb refrigerant tank, starting from atmospheric pressure.

The procedure began with a thorough vacuum purge of the hoses and the tank once all connections were established. Subsequently, four consecutive tests were conducted to gather data, and the average time required to reach 500 microns was calculated from these tests.

For the configuration change between the comparative set-up and the set-up using the instant intake fitting, it was crucial to allow the vacuum pump and oil to undergo a temperature adjustment, aiming to stabilize them at the initial configuration's temperature of 75° F. This step ensured consistency and facilitated accurate data comparison. The entire process was repeated under the new configuration, enabling the generation of comparable data for analysis.

### Equipment Used During Testing:

12 CFM Vacuum Pump—2 stage rotary vane, ¾ HP, factory rated to 15 microns
(Quantity 2) 6 ft. ½″ diameter hose ¼″×⅜″ fittings
MaxEvac™ Y-Adapter ⅜″×(2) ⅜″ fittings
Vacuum Gauge
   The Setup for the Vacuum Pump Intake Fitting with ⅜″ Fittings:
The first step removed the original fitting of the vacuum pump HVP12 12CFM and attaching the vacuum pump ⅜ fittings outlet with LOCTITE®.
The second step connected two MaxEvac™ 6-foot hoses ⅜″ fittings side to the vacuum pump ⅜″ fittings.
The third step connected two MaxEvac™ 6-foot hoses 14 fittings side to the Refrigerant tank DOT39-24 lbs.
The last step connected a UVG micron gauge ¼ fitting to the Refrigerant tank DOT39-24 lbs.

### The Setup for the Comparative MaxEvac™ Adaptor Test:

The first step connected the MaxEvac™ adaptor to the fitting ⅜″ of the vacuum pump HVP12.
The second step connected two MaxEvac™ 6-foot hoses ⅜″ fittings side to the MaxEvac™ Y-adaptor.
The third step connected two MaxEvac™ 6-foot hoses ¼″ fittings side to the Refrigerant tank DOT39-24 lbs.
The last step connected the UVG micron gauge ¼″ fitting to the Refrigerant tank DOT39-24 lbs.

The tests were run 4 times each with two 6-feet refrigeration hoses with a refrigerant tank, from the atmosphere to 500 microns. Table 1 shows the results of the four tests using the conventional Y-adapter. Table 2 shows the results of the four tests using the fitting in accordance with the embodiments disclosed herein. Table 3 compares the results.

TABLE 1

| | |
|---|---|
| First Test | 3:42:47 |
| Second Test | 3:25:17 |
| Third Test | 3:19:11 |
| Fourth Test | 3:17:53 |

TABLE 2

| | |
|---|---|
| First Test | 3:05:50 |
| Second Test | 2:57:15 |
| Third Test | 2:51:34 |
| Fourth Test | 2:52:35 |

TABLE 3

| | | Fitting Adapter | |
|---|---|---|---|
| | Conventional | of the Embodiments | Percent |
| Time | Y-adapter | Disclosed Herein | Improvement |
| Lowest Time | 3:17:53 | 2:51:34 | 16.20 |
| Average Time | 3:26:18 | 2:56:59 | 14.56 |
| Highest Time | 3:42:47 | 3:05:50 | 16.67 |

The results demonstrate the unexpected and surprisingly significant improvement obtained using the instant fitting.

While various aspects and embodiments have been disclosed herein, other aspects, embodiments, modifications and alterations will be apparent to those skilled in the art upon reading and understanding the preceding detailed description. The various aspects and embodiments disclosed herein are for purposes of illustration and are not intended to be limiting. It is intended that the present disclosure be construed as including all such aspects, embodiments, modifications and alterations insofar as they come within the scope of the appended claims or the equivalents thereof.

What is claimed is:

1. A vacuum pump assembly comprising an intake port and an intake fitting directly coupled to said intake port; said intake fitting being a unitary body having a base and a Y-shaped region extending from said base, said Y-shaped region comprising first and second angled members terminating in respective free ends, said intake fitting having an internal bore extending through said base and each first and second angled members.

2. The vacuum pump assembly of claim 1, wherein said base has external threads configured to mate with internal threads in said intake port.

3. The vacuum pump assembly of claim 1, wherein said first and second angled members each have external threads configured to mate with internal threads on first and second respective hose fitting.

4. The vacuum pump assembly of claim 3, wherein said external threads on each of said first and second angled members are sized to receive respective ⅜ inch hose fittings of a ½ inch diameter refrigeration hose.

5. The vacuum pump assembly of claim 1, wherein said intake fitting further comprises a ¼ inch port in fluid communication with said internal bore.

6. The vacuum pump assembly of claim 1, wherein said intake fitting further comprises a leg positioned between said first and second angled members and in a common plane therewith, said leg terminating in a free end.

7. The vacuum pump assembly of claim 6, wherein said leg is externally threaded and configured to mate with internal threads on a third hose fitting.

8. The vacuum pump assembly of claim 7, wherein the third hose fitting has a diameter different from a diameter of the first and second hose fittings.

9. The vacuum pump assembly of claim 1, further comprising a compressor and a drive for the compressor.

10. A connection point between an intake fitting and an intake port on a vacuum pump, the vacuum pump, the intake fitting being a unitary body having a base and a Y-shaped region extending from said base, said Y-shaped region comprising first and second angled members terminating in respective free ends, said intake fitting having an internal bore extending through said base and each first and second angled members; the connection point consisting essentially of a sealed connection between said intake port and said base of said intake fitting.
